(19) United States
(12) Patent Application Publication
(10) Pub. No.: US 2015/0109441 A1
(43) Pub. Date: Apr. 23, 2015

(54) Baby Monitoring Camera

(71) Applicant: Fuhu Holdings, Inc., El Segundo, CA (US)

(72) Inventor: Robb Fujioka, Manhattan Beach, CA (US)

(73) Assignee: Fuhu, Inc., El Segundo, CA (US)

(21) Appl. No.: 14/522,529

(22) Filed: Oct. 23, 2014

Related U.S. Application Data
(60) Provisional application No. 61/894,790, filed on Oct. 23, 2013.

(51) Int. Cl. H04N 7/18; H04N 5/33

(52) U.S. Cl. CPC H04N 7/183; H04N 5/33
USPC 348/143

(57) ABSTRACT

A system for wirelessly monitoring a remote location is disclosed. According to one embodiment, the system includes a camera, a base, and an external device. The camera includes a lens, one or more infrared (IR) sources, a status indicator, a microphone, a wireless network interface controller that connects to a Wi-Fi enabled device, and a hardware module that receives IR light when insufficient visible light is present for normal video recording and photographing. The base has a footing and a cradle that are coupled by hinges. The footing supports the camera and the base on a flat support surface. The hinges facilitate rotating the camera to position the camera at various angles. The external device wirelessly controls operation and settings of the camera to remotely view, photograph, and record videos, and to wirelessly transfer video recording data files from the camera to the external device.

### CROSS-REFERENCE TO RELATED APPLICATIONS

The present application claims priority to U.S. Patent Application No 61/894,790 filed on Oct. 23, 2013, entitled “Baby Monitoring Camera,” which is herein incorporated by reference.

### FIELD

The present disclosure generally relates to cameras for photographing and audio/video recording. More particularly, the field of the present disclosure relates to a system and a method for providing a monitoring camera to wirelessly photograph and record audio/video of a remote location where an infant or a child is sleeping.

### BACKGROUND

Traditional baby monitors generally have a radio receiver and a transmitter. The transmitter that includes an audio detector or a microphone, is placed near an infant or a child to be monitored while the radio receiver that includes a loudspeaker is worn by, or placed near, a parent or a caregiver. When the infant makes sounds, such as crying or cooing, the microphone receives the sounds, and the transmitter broadcasts the sounds in the form of radio waves to the receiver where the sounds are played over a loudspeaker for the caregiver. Some baby monitors are two-way systems that enable the caregiver to talk or sing to the infant, as well. One drawback to radio-based baby monitors, however, is that they are subject to electrical interference from other devices emitting radio frequency (RF) noise, such as radios, televisions, cell phones, fans, and home electrical wiring. Another drawback is that other sounds in the proximity of the infant, such as sounds from a baby soothing unit, a mobile, or a music box, can make distinguishing the infant's sounds difficult.

After hearing unexpected sounds on the radio receiver, the parent or caregiver enters the infant's room to investigate. Typically, the room in which the infant is sleeping is dark, or at least illuminated with low-level lighting. Upon entering the room, the caregiver allows light from other rooms to undesirably brighten the infant's room. Many times, a change in illumination awakens an otherwise peacefully sleeping infant. Alternatively, if the infant's room is quite dark, the caregiver is forced to shine a light on the infant in order to investigate the unexpected sounds heard by way of the radio receiver, and thereby disturb the infant. Therefore, there is a need for a baby monitoring system that is not subject to RF interference and audible noise confusion, and enables a caregiver to hear and view a sleeping infant without having to enter the infant's room or shine lights on the infant.

### BRIEF DESCRIPTION OF THE DRAWINGS

The accompanying drawings, which are included as part of the present specification, illustrate the various embodiments of the present disclosed system and method and together with the general description given above and the detailed description of the preferred embodiment given below serve to explain and teach the principles of the present disclosure.

FIG. 1 illustrates a perspective view of an embodiment of a baby monitoring camera, according to one embodiment;

FIG. 2 illustrates a top plan view of an embodiment of the baby monitoring camera, according to one embodiment;

FIG. 3 illustrates a bottom plan view of an embodiment of the baby monitoring camera, according to one embodiment;

FIG. 4 illustrates a front elevation view of an embodiment of the baby monitoring camera, according to one embodiment;

FIG. 5 illustrates a rear elevation view of an embodiment of the baby monitoring camera, according to one embodiment;

FIG. 6 illustrates a right-hand side elevation view of an embodiment of the baby monitoring camera, according to one embodiment;

FIG. 7 illustrates a left-hand side elevation view of an embodiment of the baby monitoring camera, according to one embodiment;

FIG. 8 is a schematic illustrating an embodiment of a direct wireless connection between an external computing device and a baby monitoring camera, according to one embodiment; and

FIG. 9 is a schematic illustrating an embodiment of a wireless connection between an external computing device and a baby monitoring camera over a real-time communications network, according to one embodiment.

It should be noted that the figures are not necessarily drawn to scale and that elements of structures or functions are generally represented by reference numerals for illustrative purposes throughout the figures. It also should be noted that the figures are only intended to facilitate the description of the various embodiments described herein. The figures do not describe every aspect of the teachings described herein and do not limit the scope of the claims.

### SUMMARY

The present disclosure describes a baby monitoring camera adapted to wirelessly photograph and record videos of a remote location where a baby, or a child, is playing or sleeping. According to one embodiment, the system includes a camera, a base, and an external device. The camera includes a lens, one or more infrared (IR) sources that emit IR light, a status indicator that conveys information about operation and status of the camera, a microphone that records audio for a video recording, a wireless network interface controller that connects to a Wi-Fi enabled device, and a hardware module that receives IR light when insufficient visible light is present for normal video recording and photographing. The base has a footing and a cradle that are coupled by hinges. The cradle has a dock to attach the camera to the cradle. The footing supports the camera and the base on a flat support surface. The hinges facilitate rotating the camera to position the camera at various angles. The external device wirelessly controls operation and settings of the camera to remotely view, photograph, and record videos, and to wirelessly transfer video recording data files from the camera to the external device.

According to one embodiment, the camera has a wireless network interface controller. According to one embodiment, the wireless network interface controller is compliant with Institute of Electrical and Electronics Engineers' (IEEE) 802.11 standards. The wireless network interface controller is configured to wirelessly connect to a Wi-Fi enabled device, for example, but not limited to, a personal computer (PC), a laptop computer, a tablet computer, a mobile computer, a mobile phone, and any other similar device capable of participating in a wireless connection with the camera. The wireless connection enables an end-user to enter commands into a Wi-Fi enabled device to control the operation and settings of the camera to remotely view, photograph, and record videos of the surroundings of the camera. Moreover, the wireless connection facilitates transferring photograph data files and video recording data files from the camera to the external device. The wireless connection may be a direct Wi-Fi connection between the camera and the Wi-Fi enabled external device. Alternatively, the wireless connection may be an access point (AP) or a mobile hotspot utilized to connect the camera to the external device by way of a real-time communication network, such as the Internet or a cloud-computing network. In the case of the cloud-computing network, a cloud server, hosted by a service provider, stores software applications and user-related data that facilitate exchanging data between the external device and the camera. The cloud server may also include software that enables live broadcasting of video from the camera to the Wi-Fi enabled external device via the wireless connection.

According to one embodiment, the IR sources automatically turn on when there is insufficient visible light for normal photographing and video recording. According to another embodiment, the IR sources are manually turned on by an end-user of the camera. In one embodiment, the IR sources are IR light emitting diodes (LEDs).

According to one embodiment, the lens comprises a fixed focal length lens having an effective focal length (EFL) of 2.3 millimeters (mm) and an aperture size of F/2.2. According to one embodiment, the lens has a view angle of substantially 100-degrees and a focal range of at least substantially 25 centimeters (cm). According to one embodiment, the lens has an active IR band pass ranging between substantially 700 nanometers (nm) and 1000 nm. According to one embodiment, the lens has an IR narrow band pass ranging between substantially 842 nm and 858 nm, and has an IR cut-off at substantially 650 nm.

According to one embodiment, the camera further has internal firmware that supports photographing still images, recording video and audio, converting the recordings to data files, and storing the files on a removable memory. According to one embodiment, the data files comprise JPEG format for photograph files and MPEG-4 Part 14 (MP4) for video files. According to one embodiment, the internal firmware supports a resolution of 1280×729 pixels and H.264 video compression.

According to one embodiment, the camera has a card slot that is configured to receive an external memory storage card. For example, the external memory storage card is a micro secure digital (Micro SD) storage card.

According to one embodiment, the camera has a micro universal serial bus (USB) port configured to receive a power adapter that receives electrical power from a power outlet. The micro USB port further enables the camera to connect to an external device via a USB cable such that software applications may be installed from the camera onto the external device. The micro USB connection enables a transfer of photographs and video data files from the micro SD card to the external device. In one embodiment, the micro USB port is positioned on a bottom surface of the exterior case of the camera such that the micro USB port and a power adapter cord are hidden from view at the front of the camera, thereby isolating the power adapter cord from children.

According to one embodiment, a power button positioned on a top surface of the camera, such that the camera may be turned on and off. The power button serves a dual function of enabling an end-user to take photographs and record videos.

According to one embodiment, a bottom surface of the footing further has one or more supportive buttons that provide friction between the base and the flat support surface to prevent the monitoring camera from sliding on the flat support surface. According to one embodiment, fasteners are used in lieu of the supportive buttons such that the camera is mountable to supportive surfaces having orientations other than the flat support surface.

According to one embodiment, a backside of the camera includes fastening structures that facilitate mounting the camera to preselected support bases other than the base. In another exemplary embodiment, the fastening structures facilitate mounting the camera onto a vertical support surface.

According to one embodiment, the base further includes two limbs that have opposite sides of the cradle and the dock. Each of the limbs includes a rail configured to be received into a correspondingly configured slot in an exterior side of the camera, such that the camera is inserted into the dock by aligning the slots with the corresponding rails and sliding the slots onto the rails such that the camera is received into the dock.

According to one embodiment, a status indicator has at least one light emitting diode (LED) that emits at least one color to indicate the status of the camera. The at least one color of the at least one status indicator are flashed, or pulsed intelligently to convey information to an end-user of the camera. The at least one color and pulsing of the at least one status indicator are accompanied by audible sounds emitted by way of a speaker within the camera. According to one embodiment, the at least one status indicator comprises a first status indicator positioned on a top surface of the camera and a second status indicator positioned on a front surface of the camera.

According to one embodiment, a method for wirelessly monitoring a remote location includes establishing a wireless connection between an external device and a camera. The camera lens is configured for photographing and video recording, one or more infrared (IR) sources configured to emit IR light, a microphone configured to record audible sounds accompanying the video recordings, and a wireless network interface controller (Wi-Fi) that is configured to wirelessly connect to Wi-Fi enabled devices. The lens is configured and coupled with internal hardware suitable for receiving the IR light when insufficient visible light is present for normal video recording and photographing. The method further includes entering commands into the external device to control the operation and settings of the camera via the wireless connection to remotely view, photograph, and record videos of the surroundings of the camera. The method further includes transferring photograph data files and video recording data files from the camera to the external device via the wireless connection.

The above and other preferred features, including various novel details of implementation and combination of elements, will now be more particularly described with reference to the accompanying drawings and pointed out in the claims. It is understood that the particular methods and systems are shown by way of illustration only and not as limitations. As will be understood by those skilled in the art, the principles and features explained herein may be employed in various and numerous embodiments.

### DETAILED DESCRIPTION

A baby monitoring camera system and a method for monitoring is disclosed. The baby monitoring camera system includes a camera and a base. The camera includes a lens, one or more infrared (IR) sources configured to emit IR light, at least one status indicator configured to convey information about operation and status of the camera, a microphone configured to record audible sounds accompanying video recordings, and a wireless network interface controller configured to wirelessly connect to a Wi-Fi enabled device. The lens is configured and coupled with internal hardware of the camera suitable for receiving an IR light when insufficient visible light is present. The base includes a footing and a cradle that are coupled by hinges. The cradle includes a dock configured to receive at least a lower portion of the camera to removably attach the camera to the cradle.

In the following description, for purposes of clarity and conciseness of the description, not all of the numerous components shown in the schematic are described. The numerous components are shown in the drawings to provide a person of ordinary skill in the art a thorough enabling disclosure of the present system and method. The operation of many of the components would be understood to one skilled in the art.

Each of the additional features and teachings disclosed herein can be utilized separately or in conjunction with other features and teachings to provide a system and method for providing curated content. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the present disclosure. Therefore, combinations of features disclosed in the following detailed description may not be necessary to practice the teachings in the broadest sense and are instead taught merely to describe particularly representative examples of the present teachings.

Moreover, various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission display devices.

In the following description, numerous specific details are set forth, such as examples of specific data signals, named components, connections, etc., in order to provide a thorough understanding of the present disclosure. It is apparent, however, to one of ordinary skill in the art that the present disclosure may be practiced without these specific details. In other instances, well known components or methods have not been described in detail but rather in a schematic in order to avoid unnecessarily obscuring the present disclosure. Further specific numeric references, such as first status indicator, may be made. However, the specific numeric reference should not be interpreted as a literal sequential order but rather interpreted that the first status indicator is different than a second status indicator. Thus, the specific details set forth are merely exemplary. The specific details may be varied from and still be contemplated to be within the spirit and scope of the present disclosure. Moreover, the term “coupled” is defined as meaning connected either directly to the component or indirectly to the component through another component.

The present disclosure describes a baby monitoring camera and a method thereof to wirelessly photograph and record videos of a remote location where an infant or child is sleeping. In one embodiment, the baby monitoring camera has a camera mounted on a base that is configured to support the camera on a flat horizontal surface. The camera has a lens configured for photographing and video recording. Infrared (IR) sources on the camera emit active IR light when insufficient visible light is present for normal video recording and photographing. A wireless network interface controller (Wi-Fi) of the camera is configured to wirelessly connect to a Wi-Fi enabled device that is capable of participating in a wireless connection with the camera. The wireless connection enables an end-user to control the operation and settings of the camera using a Wi-Fi enabled device, so as to remotely view, photograph, and record audio/videos of the surroundings of the camera. The wireless connection may be a direct Wi-Fi connection between the camera and the Wi-Fi enabled device, or may be an access point (AP) or a mobile hotspot utilized to connect the camera to the Wi-Fi enabled device by way of a real-time communication network, such as the Internet or a cloud computing network. It is recognized that the cloud-computing network may include a cloud server, hosted by a service provider that stores software applications and user-related data that facilitate exchanging data between the Wi-Fi enabled device and the camera. The cloud server may also include software that enables live broadcasting of video from the camera to the Wi-Fi enabled device via the wireless connection. It is further recognized that the monitoring camera disclosed herein is particularly well-suited for wirelessly monitoring a sleeping infant. However, it should be understood that the monitoring camera of the present disclosure is not limited solely to monitor sleeping infants. Rather, those skilled in the art would instantly recognize that the monitoring camera of the present disclosure is particularly well suited for monitoring any individuals in need of supervision, including, for example, but not necessarily limited to, children, the elderly, handicapped individuals, patients, pets, as well as any other similar individuals.

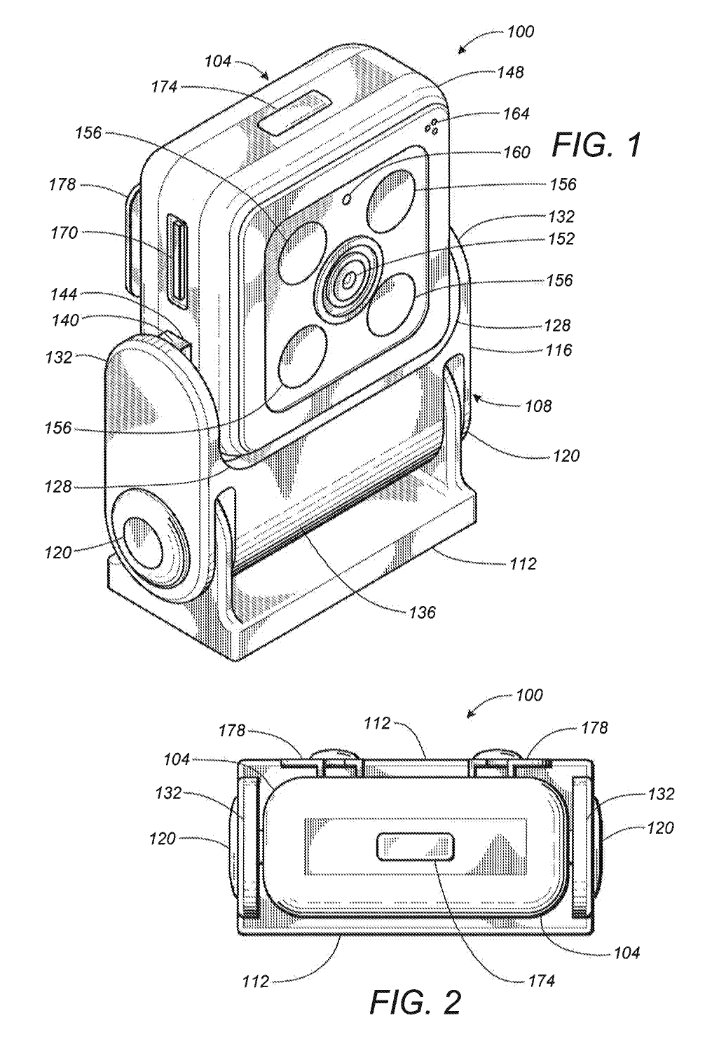

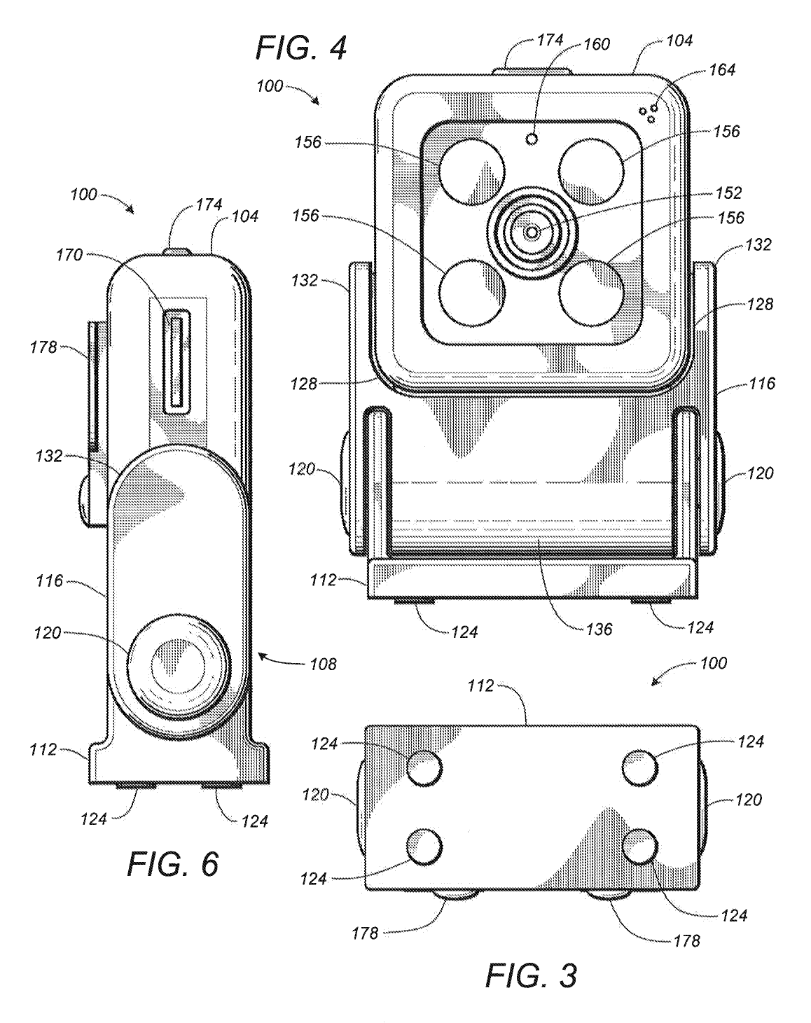

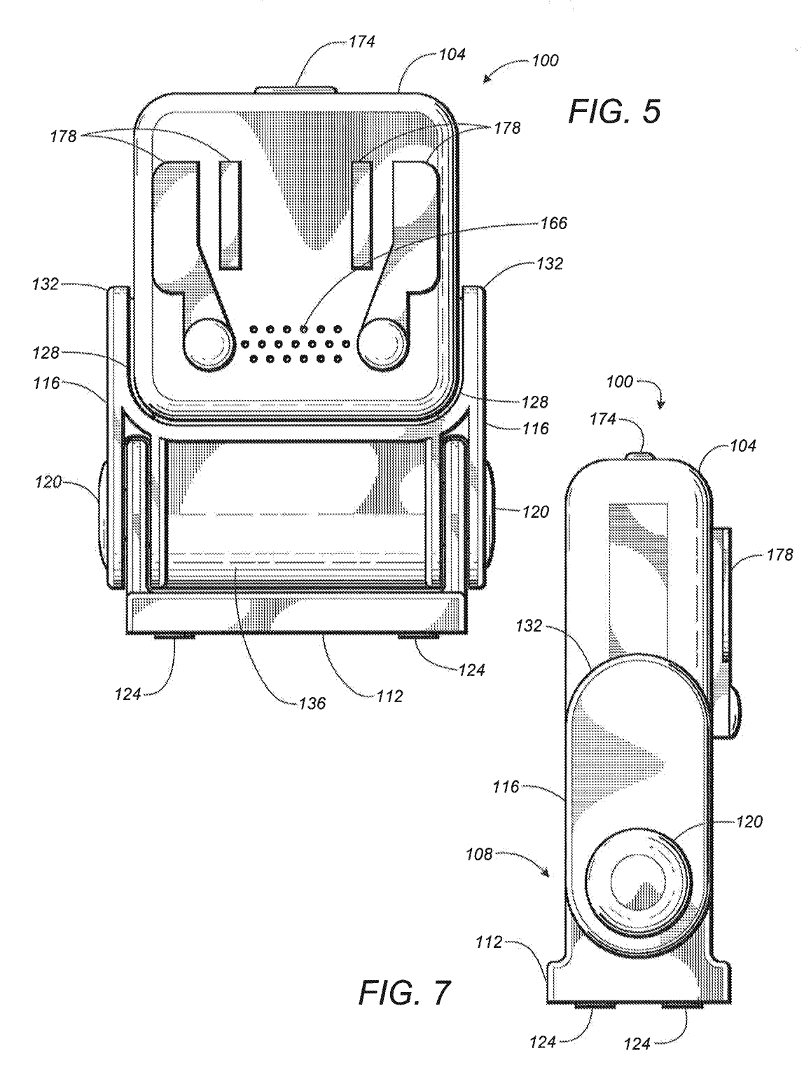

FIGS. 1-7 illustrate an exemplary embodiment of a baby monitoring camera in accordance with the present disclosure. FIG. 1 illustrates a perspective view of an embodiment of a baby monitoring camera, according to one embodiment. FIG. 2 illustrates a top plan view of an embodiment of the baby monitoring camera, according to one embodiment. FIG. 3 illustrates a bottom plan view of an embodiment of the baby monitoring camera, according to one embodiment. FIG. 4 illustrates a front elevation view of an embodiment of the baby monitoring camera, according to one embodiment. FIG. 5 illustrates a rear elevation view of an embodiment of the baby monitoring camera, according to one embodiment. FIG. 6 illustrates a right-hand side elevation view of an embodiment of the baby monitoring camera, according to one embodiment. FIG. 7 illustrates a left-hand side elevation view of an embodiment of the baby monitoring camera, according to one embodiment.

The baby monitoring camera 100 has a camera 104 attached to a base 108. The base 108 has a footing 112 and a cradle 116 that are coupled by hinges 120. The base 108 is configured to support the baby monitoring camera 100 on a flat horizontal surface, such as a table or a desk, or other similar support surface. A bottom surface of the footing 112 has a multiplicity of supportive buttons 124 that advantageously provides friction between the base 108 and the horizontal surface to prevent the baby monitoring camera 100 from sliding on the horizontal surface. It is appreciated that although four supportive buttons 124 are shown in FIGS. 3-7, different numbers of the supportive buttons 124 may be utilized within the scope of the present disclosure. It is further appreciated that fasteners may be used in lieu of the supportive buttons 124, such that the baby monitoring camera 100 may be mounted to supportive surfaces having orientations other than horizontal without deviating from the scope of the present disclosure.

The cradle 116 is configured to fixedly receive the camera 104. Referring to FIG. 1, the cradle 116 has a dock 128, limbs 132, a rounded portion 136, as well as the hinges 120 shared with the footing 112. The hinges 120 facilitate rotating the camera 104 relative to the footing 112 to position the camera 104 at various angles with respect to the footing 112. The hinges 120 provide a level of resistance to motion, such that the camera 104 remains positioned at a desired angle after being rotated relative to the footing 112. The rounded portion 136 allows the cradle 116 to rotate, by way of the hinges 120, without being obstructed by portions of the footing 112. A variety of other suitable types of hinges would be apparent to those of ordinary skill within the scope of the present disclosure.

The dock 128 is configured to receive at least a lower portion of the camera 104 such that the camera 104 may be removably attached to the cradle 116. To this end, the camera 104 has an exterior case 148 of a generally parallelepiped configuration, although other configurations and shapes of the exterior case 148 may be employed within the scope of the present disclosure. The limbs 132 have opposite sides of the cradle 116 and opposing sides of the dock 128. Each of the limbs 132 includes a rail 140 configured to be received into a correspondingly configured slot 144 in a side of the exterior case 148 of the camera 104. The camera 104 may be inserted into the dock 128 by aligning the slots 144 in the sides of the camera 104 with the corresponding rails 136 on the opposing sides of the dock 128 and then sliding the slots 144 onto the rails 140 such that the camera 104 is received into the dock 128. The rails 140 and the slots 144 may be configured to provide a degree of friction between each rail 140 and the corresponding slot 144 suitable to maintain the camera 104 within the dock 128 while allowing for easy docking and removal of the camera 104 from the dock 128. Moreover, as illustrated in FIG. 5, a backside of the camera 104 includes fastening structures 178 that facilitate mounting the camera 104 onto various preselected support bases other than the base 108. The fastening structures 178 facilitate mounting the camera 104 onto a vertical support surface by way of appropriate fastening hardware. In an embodiment, the fastening structures 178 are configured to be received by a mounting base that is configured to be fastened to the vertical support surface. Accordingly, it is recognized that a wide variety of different embodiments of the fastening structures 178 may be utilized within the scope of the present disclosure.

The camera 104 has a camera lens 152, infrared (IR) sources 156, a status indicator 160, and a microphone 164. The status indicator 160 conveys information about the operation of the camera 100. In one embodiment, the status indicator 160 has one or more light emitting diodes (LEDs) that emit multiple colors, such as by way of example, green, orange, and red, to indicate the status of the camera 100. The colors of the status indicator 160 may be flashed, or pulsed intelligently to convey information to the end-user. The colors and pulsing of the status indicator 160 may be accompanied by audible sounds, such as beeping or other similar audible sounds, by way of a speaker 166, as illustrated in FIG. 5. It is appreciated by those skilled in the art that the status indicator 160 may be advantageously positioned on the top of the camera 104 in lieu of being positioned at the front of the camera. In one embodiment, a first status indicator 160 and a second status indicator are respectively positioned on the top and at the front of the camera 104.

The speaker 166 may perform functions beyond beeping in unison with the flashing of the status indicator 160. In an embodiment, the speaker 166 is utilized to play music, or other soothing sounds to a sleeping infant or child. It is envisioned that the camera 104 may include a collection of stored soothing sounds that may be selected by the end-user and then played continuously while the infant sleeps. Stored soothing sounds may include, but are not necessarily limited to ocean waves, trickling creek water, water fall, air conditioning, singing birds, chirping frogs, nighttime forest sounds, and other similar sounds that are commonly regarded as soothing to infants and children. Stored music may include calming lullabies that typically are sung to sooth infants during nighttime hours. In another embodiment, the speaker 160 enables a parent or caregiver to speak or sing to the infant, as needed.

The IR sources 156 emit IR light when insufficient visible light is present for video recording and photographing. The IR sources 156 preferably are active IR light emitting diodes (IR LEDs), although other sources of IR light would be apparent to those skilled in the art. Referring to FIGS. 1 and 4, four of the IR sources 156 are utilized with the baby monitoring camera 100. In an embodiment, the IR sources 156 automatically turn on when there is insufficient visible light for normal photographing and video recording. In another embodiment, the IR sources 156 a turned on by an end-user of the camera 104. It is appreciated, however, that the present disclosure is not limited to four IR sources 156. Rather, any number of IR sources may be used in conjunction with the baby monitoring camera 100 of the present disclosure.

The camera lens 152 is suitably configured and coupled with appropriate internal hardware or photographing still images, as well as recording videos. During video recording, the microphone 164 enables the camera 104 to record audible sounds accompanying the videos. In an embodiment, the camera lens 152 is of the fixed focal length variety. In one embodiment, the camera lens 152 may have an effective focal length (EFL) of 2.3 millimeters (mm) and an aperture size of F/2.2. In another embodiment, the camera lens 152 has a view angle of substantially 100-degrees, and a minimum focal range of substantially 25 centimeters (cm). Moreover, the camera lens 152 is capable of receiving the IR light emitted from the IR sources 156 when insufficient visible light is present for normal video recording and photographing. In one embodiment, the camera lens 152 has an active IR band pass ranging between substantially 700 nanometers (nm) and 1000 nm. The camera lens 152 may have an IR narrow band pass ranging between substantially 842 nm and 858 nm, with an IR cut-off at substantially 650 nm. It should be understood that the camera lens 152 may have a wide variety of other configurations and specifications without deviating from the spirit and scope of the present disclosure.

The camera 104 has internal firmware that supports photographing still images, as well as recording video and audio, converting the recordings to data files, and storing the files on a removable memory. The data files may be formatted into popular file formats, such as, by of example, JPEG format for photograph files and MPEG-4 Part 14 (MP4) for video files. In one embodiment, the internal firmware supports a resolution of 1280×729 pixels. In another embodiment, the firmware supports a video compression standard, such as, by way of example, H.264 Video. Those skilled in the art would recognize that a wide variety of photograph and video standards may be implemented with the baby monitoring camera 100 without straying from the scope and spirit of the present disclosure.

Referring to FIG. 1, the camera 104 has a card slot 170 that is suitably configured to receive an external storage card. In one embodiment, the card slot 170 is configured to receive removable memory, such as a micro secure digital (micro SD) storage card. In another embodiment, the card slot 170 and the internal firmware are configured to receive micro SD cards having storage capacities ranging up to substantially 64 Gigabytes (GB), or greater. It is envisioned that the firmware and the card slot 170 may be configured to operate with other similar types of external storage cards having other storage capacities without deviating from the scope of the present disclosure.

According to one embodiment, the camera 104 comprises a micro universal serial bus (USB) port that is suitably configured to receive a power adapter cord that receives electrical power from a power outlet. The Micro USB port may serve the additional function of enabling the end-user to connect the camera 104 to an external device by way of a USB cable. In one embodiment, the micro USB connection enables the end-user to install software applications from the camera 104 onto the external device. In another embodiment, the micro USB connection enables transferring photographs and video data files from the micro SD card to the external device. Moreover, the micro USB port may be advantageously positioned on a bottom surface of the exterior case 148 of the camera 104 to be positioned behind the rounded portion 136 when the camera 104 is in the dock 128. The micro USB port and the power adapter cord are hidden from view at the front of the baby monitoring camera 100, thereby reducing the possibility of a child touching or coming into contact with the power adapter cord and electrical power from the power outlet.

According to one embodiment, a power button 174 is positioned on a top surface of the camera 104. In one embodiment, the power button 174 enables the end-user of the baby monitoring camera 100 to turn the camera 104 on and off. In another embodiment, the power button 104 may serve a dual function of enabling the end-user to take photographs and record videos. For example, the end-user presses and holds down the power button 174 for a predetermined duration of time, for example, two seconds, to turn the camera 104 on and off. In another embodiment, when the camera 104 is already powered on, quickly pressing the power button 174 a first time starts a video recording, and pressing the power button 174 a second time stops the recording. Other functions of the power button 174 are apparent to those skilled in the art within the scope of the present disclosure.

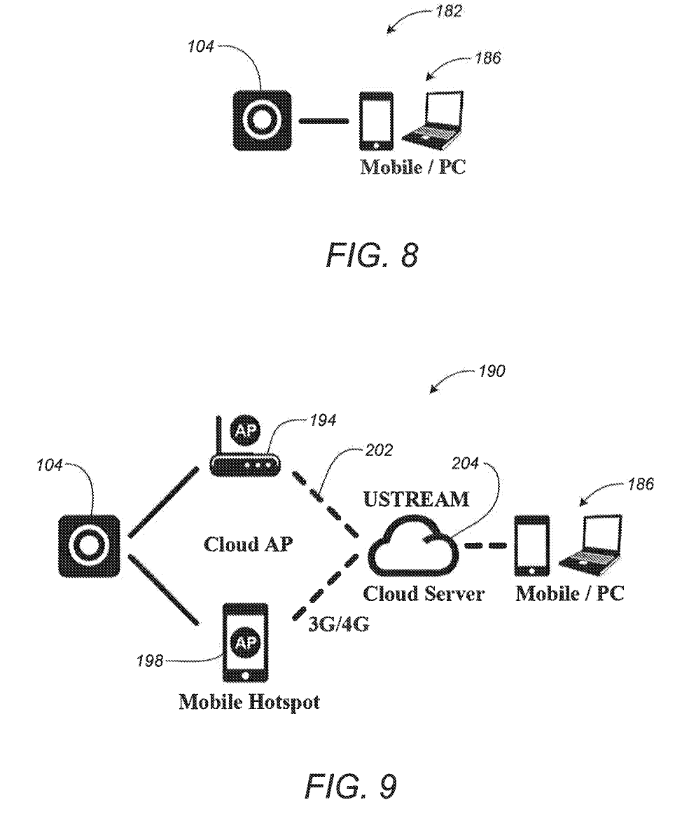

FIG. 8 is a schematic illustrating an embodiment of a direct wireless connection, according to one embodiment. The direct wireless connection 182 facilitates exchanging data between an external device 186 and the camera 104. The wireless connection 182 between the camera 104 and the external device 186 also facilitates remote operation of the camera 104 by an end-user operating the external device 186. The external device 186 may be a personal computer (PC), a laptop computer, a tablet computer, a mobile computer, a mobile phone, and any other similar device capable of participating in the wireless connection 182. In one embodiment, the camera 104 includes a wireless network interface controller (e.g., a Wi-Fi controller) that is configured to wirelessly connect to a Wi-Fi enabled device. In another embodiment, the camera 104 is compliant with Institute of Electrical and Electronics Engineers' (IEEE) 802.11 standards.

FIG. 9 is a schematic illustrating an embodiment of a wireless connection between an external device and a camera over a real-time communications network, according to one embodiment. A wireless connection 190 is substantially similar to the wireless connection 182, with an exception that the wireless connection 190 utilizes an access point (AP) 194 or a mobile hotspot 198 to connect the camera 104 to the external device 186 by way of a real-time communication network 202, for example, the Internet. In one embodiment, the real-time communication network 202 is a cloud-computing network. The end-user utilizes the external device 186 to access and operate the camera 104 via one or more cloud servers 204 that are hosted by an appropriate service provider. The cloud servers 204 may store software applications and user-related data that facilitate exchanging video recording files, photograph files, and other similar data files between the external device 186 and the camera 104 via the wireless connection 190. The cloud servers 204 may include software that enables live broadcasting of video from the camera 104 to the external device 186.

The wireless connections 182 and 190 enable an end-user of the external device 186 to utilize the camera 104 for real-time remote viewing, photographing, as well as video recording. In one embodiment, the wireless connections 182 and 190 enable the user to remotely control operation and settings of the camera 104 from the external device 186. In another embodiment, the wireless connections 182 and 190 enable the end-user to remotely view, photograph, and record videos of the surroundings of the camera 104 in absence of sufficient visible light by using the IR sources 156. In still another embodiment, the wireless connections 182 and 190 enable the end-user to transfer photograph and video data files from the camera 104 to the external device 186. Moreover, the microphone 164 enables audible sounds occurring near the camera 104 to be transmitted to the end-user by way of the wireless connections 182 and 190, as well as including sounds in video recordings. The speaker 166 enables the end-user to broadcast sounds to the surroundings of the camera 104 by way of the wireless connections 182 and 190.

Those skilled in the art would instantly recognize that the camera 104 and the wireless connections 182 and 190 are particularly well suited for monitoring any individuals in need of supervision, especially during sleep, for example, infants, children, the elderly, handicapped individuals, patients, pets, as well as any other similar individuals. In the case of a sleeping infant, the camera 104 transmits the infant's crying or cooing sounds to a caregiver by way of the microphone 164, and the camera lens 152 and IR sources 156 enable the caregiver to view the infant's status in low-level light without disturbing the infant. The speaker 166 further enables the caregiver to speak, sing, or play music, to sooth the infant, if needed. Those skilled in the art would further recognize that a wide variety of functions may be performed by way of the baby monitoring camera 100 and the wireless connections 182 and 190 without deviating from the spirit and scope of the present disclosure.

While some specific embodiments of the present disclosure have been shown, the present disclosure is not to be limited to these embodiments. For example, most functions performed by electronic hardware components may be duplicated by software emulation. Thus, a software program written to accomplish those same functions may emulate the functionality of the hardware components in input-output circuitry. The present disclosure is to be understood as not limited by the specific embodiments described herein, but only by scope of the appended claims.

I claim:

1. A system for wirelessly monitoring a remote location, the system comprising:
a camera that includes,
a lens;
one or more infrared (IR) sources that emit IR light;
a status indicator that conveys information about operation and status of the camera;
a microphone that records audio for a video recording;
a wireless network interface controller that connects to a Wi-Fi enabled device; and
a hardware module that receives IR light when insufficient visible light is present for normal video recording and photographing; and
a base that has a footing and a cradle that are coupled by hinges,
wherein the cradle has a dock to attach the camera to the cradle,
wherein the footing supports the camera and the base on a flat support surface, and
wherein the hinges facilitate rotating the camera to position the camera at various angles; and
an external device that wirelessly controls operation and settings of the camera to remotely view, photograph, and record videos, and to wirelessly transfer video recording data files from the camera to the external device.

2. The system of claim 1, wherein the external device is selected from a group comprising a personal computer (PC), a laptop computer, a tablet computer, a mobile computer, a mobile phone, and an electronic device that is capable of participating in a wireless connection with the camera.

3. The system of claim 2, wherein the wireless connection comprises an access point (AP) or a mobile hotspot configured to connect the camera to the external device via the Internet.

4. The system of claim 1, wherein the one or more IR sources automatically turn on when there is insufficient visible light for normal photographing and video recording.

5. The system of claim 1, wherein the one or more IR sources are manually turned on by a user of the camera.

6. The system of claim 1, further comprising a power button positioned on a top surface of the camera, wherein the power button is used to turn on and off the power and take photographs and record videos.

7. The system of claim 1, wherein a bottom surface of the footing comprises one or more supportive buttons that provide friction between the base and the flat support surface and prevent the camera from sliding on the flat support surface.

8. The system of claim 7, wherein fasteners are used in lieu of the one or more supportive buttons to mount the camera to a supportive surface that has an orientation other than the flat support surface.

9. The system of claim 1, wherein a backside of the camera includes fastening structures that facilitate mounting the camera to a preselected support base other than the base.

10. The system of claim 9, wherein the fastening structures facilitate mounting the camera onto a vertical support surface.

11. The system of claim 1, wherein the base further comprises two limbs comprising opposite sides of the cradle and the dock,
wherein each of the limbs includes a rail configured to be received into a correspondingly configured slot in an exterior side of the camera, and
wherein the camera is inserted into the dock by aligning the slots with the corresponding rails and sliding the slots onto the rails to place the camera into the dock.

12. The system of claim 1, wherein the status indicator comprises a first status indicator positioned on a top surface of the camera and a second status indicator positioned on a front surface of the camera.

13. A method for wirelessly monitoring a remote location, the method comprising:
establishing a wireless connection between an external device and a camera,
wherein the camera includes a lens, one or more infrared (IR) sources that emit IR light, a microphone that records audio for a video recording, a wireless network interface controller that connects to Wi-Fi enabled devices, and a hardware module that receives IR light when insufficient visible light is present for normal video recording and photographing,
entering commands into the external device to control operation and settings of the camera via the wireless connection to remotely view, photograph, and record videos of the surroundings of the camera; and
transferring video recording data files from the camera to the external device.

14. The method of claim 13, wherein the external device comprises a personal computer (PC), a laptop computer, a tablet computer, a mobile computer, a mobile phone, and a device capable of participating in the wireless connection with the camera.

15. The method of claim 13, further comprising turning on at least one of the one or more IR sources when there is insufficient visible light for normal photographing and video recording.

16. The method of claim 13, further comprising forming a direct Wi-Fi connection between the wireless network interface controller and a wireless network interface controller onboard the external device.

17. The method of claim 13, further comprising utilizing an access point (AP) or a mobile hotspot to connect the camera to the external device by way of a real-time communication network.

18. The method of claim 17, wherein the real-time communication network comprises the Internet.

19. The method of claim 17, wherein the real-time communication network comprises a cloud-computing network wherein the external device is utilized to access and operate the camera via one or more cloud servers that are hosted by a service provider.

20. The method of claim 19, wherein the one or more cloud servers include software that enables live audio/video broadcasting from the camera to the external device via the wireless connection.
